(19) United States
(12) Patent Application Publication
(10) Pub. No.: US 2013/0019795 A1
(43) Pub. Date: Jan. 24, 2013

(54) System and Assembly for Flying a Flag at High Speeds

(71) Applicants: Eugene Ernest Leptien, Wausau, WI (US); Ronald John Leptien, Wausau, WI (US)

(72) Inventors: Eugene Ernest Leptien, Wausau, WI (US); Ronald John Leptien, Wausau, WI (US)

(73) Assignee: ISM INDUSTRIES, Wausau, WI (US)

(21) Appl. No.: 13/553,196

(22) Filed: Jul. 19, 2012

Related U.S. Application Data
(60) Provisional application No. 61/509,132, filed on Jul. 19, 2011.

(51) Int. Cl. G09F 17/00

(52) U.S. Cl. 116/173

(57) ABSTRACT

An assembly for flying a flag at high speeds includes a pole. First and second wing assemblies are coupled to the pole and extend away from the pole angled in the direction of the back of the pole. The first wing assembly includes a first slot through the first wing assembly. The second wing assembly includes a second slot through the second wing assembly. The first and second slots are parallel to the pole.

### CROSS REFERENCE TO RELATED APPLICATION

This application relates to and claims priority from U.S. Provisional Application Ser. No. 61/509,132 filed on Jul. 19, 2011, which is hereby incorporated by reference in its entirety.

### FIELD OF THE DISCLOSURE

The present disclosure is related to flag poles. More specifically, the present disclosure is related to a flag pole for flying a flag at high speeds.

### BACKGROUND

Flags of all varieties are popular decorations for personal and commercial vehicles. As the vehicles moves, air flows past the flag causing the flag to wave. This has a pleasant and aesthetically pleasing effect when the vehicle speed is relatively low; however, as the vehicle speed increases, adverse effects can be observed in the flying of the flag. One adverse effect is that a vacuum can be created behind the flag pole which causes the flag to be drawn tight against the flag pole and thus cease to fly in the desired manner. Alternatively, the high speed of the air traveling past the flag can cause the free end of the flag to whip about vigorously, which can quickly damage the flag. In some instances, it has been observed that a single trip of a vehicle traveling at high speeds can destroy a flag through tearing and fraying caused by this whipping.

### BRIEF DISCLOSURE

An assembly for flying a flag at high speeds includes a pole having an elongated dimension, a front, and a back, wherein the back is configured to receive the flag. A first wing assembly is coupled to the pole and the first wing assembly extends away from the pole angled in the direction of the back of the pole. A second wing assembly is coupled to the pole and the second wing assembly extends away from the pole angled in the direction of the back of the pole. A first slot in the first wing assembly is parallel to the elongated dimension of the pole. A second slot in the second wing assembly is parallel to the elongated dimension of the pole.

An assembly for flying a flag from a vehicle at high speeds includes a pole having an elongated dimension, a top, and a bottom. A first face extends away from the pole. A second face extends away from the pole is a direction opposed to the first face. A first wing is coupled to the first face at a first shoulder and extends away from the shoulder at an obtuse angle to the first face. A second wing is coupled to the second face at a second shoulder and extends away from the second shoulder at an obtuse angle to the second face. A first slot through the first face has an elongated dimension parallel to the elongated dimension of the pole. A second slot through the second face has an elongated dimension parallel to the elongated dimension of the pole. A bracket is secured to the bottom of the pole and the bracket is configured to mount to a portion of the vehicle.

A system for decorating a vehicle includes a pole having an elongated dimension, a top, a bottom, a front, and a back. The pole further includes an axial bore through the pole. A slot extends from the axial bore through the pole to the back of the pole. A flag includes a fastening loop along a vertical dimension and a flag body extending in a horizontal direction away from the fastening loop. The fastening loop is partially received within the axial bore and extends out of the pole through the slot and the flag body extends generally away from the back of the pole. A first face extends away from the pole. A second face extends away from the pole in a direction opposed to the first face. A first wing is coupled to the pole by the first face. The first wing is coupled to the first face at a first shoulder and extends away from the first shoulder at an obtuse angle to the first face. A second wing is coupled to the pole by the second face. The second wing is coupled to the second face at a second shoulder and extends away from the second shoulder at an obtuse angle to the second face. A first slot through the first face has an elongated dimension parallel to the elongated dimension of the pole. A second slot through the second face has an elongated dimension parallel to the elongated dimension of the pole. A bracket is secured to the bottom of the pole and is configured to mount to a portion of the vehicle.

### BRIEF DESCRIPTION OF THE DRAWINGS

FIG. 1 is a front view of an embodiment of a flag assembly as disclosed herein.

FIG. 2 is a cross sectional view of the flag assembly of FIG. 1 taken along the line 2-2.

FIG. 3 is a cross sectional view of the flag assembly of FIG. 1 taken along the line 3-3.

FIG. 4 is a cross sectional view of the flag assembly taken along the line 4-4.

FIG. 5 is an alternative cross sectional view of the flag assembly taken along the line 4-4.

FIG. 6 is a front view of an embodiment of a flag assembly.

FIG. 7 is a rear view of an embodiment of the flag assembly.

FIG. 8 is a right side view of an embodiment of the flag assembly.

FIG. 9 is a left side view of an embodiment of the flag assembly.

FIG. 10 is a top view of an embodiment of the flag assembly.

FIG. 11 is a bottom view of an embodiment of the flag assembly.

FIG. 12 is an isometric view of an embodiment of the flag assembly.

### DETAILED DISCLOSURE

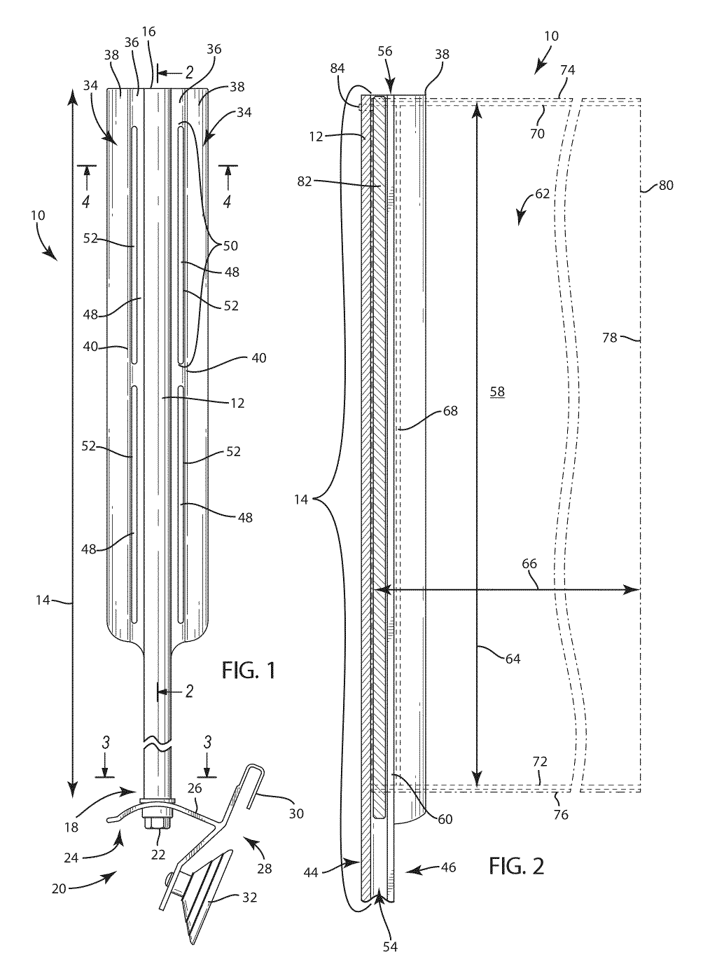

FIG. 1 depicts an embodiment of a flag assembly 10. The flag assembly 10 includes a pole 12 that has an elongated dimension 14. The pole 12 further terminates in a top 16 and a bottom 18.

A bracket 20 is secured to the bottom 18 of the pole 12. In the embodiment depicted in FIG. 1, the bracket 20 is secured to the bottom 18 of the pole 12 by a nut 22; however, it will be recognized that in alternative embodiments, the other arrangements for securing can be used, including a threaded bolt that is received by threads (not depicted) exemplarily internal to the pole 12.

The bracket 20 includes a pole adjustment bracket 24 that includes an engagement surface 26 which physically engages the bottom 18 of the pole 12. The engagement surface 26 of the pole adjustment bracket 24 defines a plurality of angles between which the bottom 18 and the engagement surface 26 can be held and secured by the nut 22. The pole adjustment bracket 24 is connected to a vehicle mounting bracket 28. The vehicle mounting bracket is configured to mount the flag pole 10 to a vehicle in such a manner as to retain the flag pole 10 secured to the vehicle as a vehicle travels at high speeds, as will be described in further detail herein. In the embodiment depicted in FIG. 1, the vehicle mounting bracket includes a window hook 30 that is configured to secure over a window of a vehicle and a suction cup 32 that is configured to removably attach to a portion of the vehicle, exemplarily a window. It is to be recognized that an alternative embodiment, the vehicle mounting bracket 28 may include other configurations, such as clamps or bolts that may be dictated by a specific structure on a vehicle to which the flag pole is to be mounted.

As will be described in further detail herein, two wing assemblies 34 extend away from the pole 12. Each of the wing assemblies 34 extend away from the pole 12 and are generally opposed to each other. In the embodiment depicted in FIG. 1, the wing assembly 34 includes a face 36 and a wing 38. As can be seen in greater detail with respect to the cross sectional view shown in FIG. 4, the face 36 of the wing assembly 34 extends away from the pole 12 in a direction normal to the pole 12. The faces 36 extend from the pole 12 is opposed directions from one another. The wing 38 connects to the face 36 at a shoulder 40. The wings 38 extend at an obtuse angle 42 from the face 36. The pole 12 has a front 44 and an opposed back 46. The wings 38 extend away from the pole 12 and the face 36 in the direction towards the back 46 of the pole 12.

Referring back to FIG. 1, each wing assembly 34 includes at least one slot 48 through the wing assembly 34. In the embodiment depicted in FIG. 1, each wing assembly 34 has two slots through the wing assembly. In an alternative embodiment, any number of slots may be used consistent with the disclosure as provided herein. While not depicted in the embodiment of the flag pole 10 depicted in FIG. 1, in some embodiments, the slot 48 can be through the wing 38. FIG. 1 depicts the slot 48 is through the face 36. In an alternative embodiment (not depicted), the wing assembly only includes a wing that extends away from the pole and a slot is disposed within the wing. In the embodiment depicted in FIG. 1, the slots 48 generally include an elongated dimension 50 which is aligned with the elongated dimension 14 of the pole 12. In different embodiments, the position of the slot 48 through the face 36 may include various arrangements. In the embodiment depicted in flag assembly 10 of FIG. 1, the slot 48 is aligned such that an outside edge 52 of each slot 48 is aligned on the shoulder 40 of the wing assembly 34; however, it will be understood that in alternative embodiments, the slot 48 can be aligned in various other positions on the face 36, or in still further embodiments, in the wing 38.

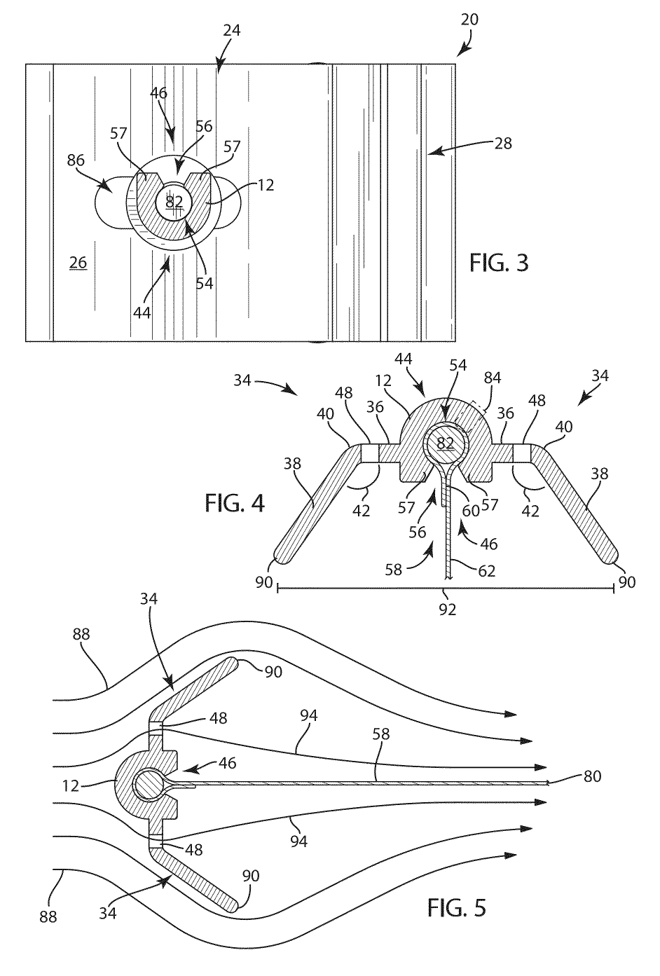

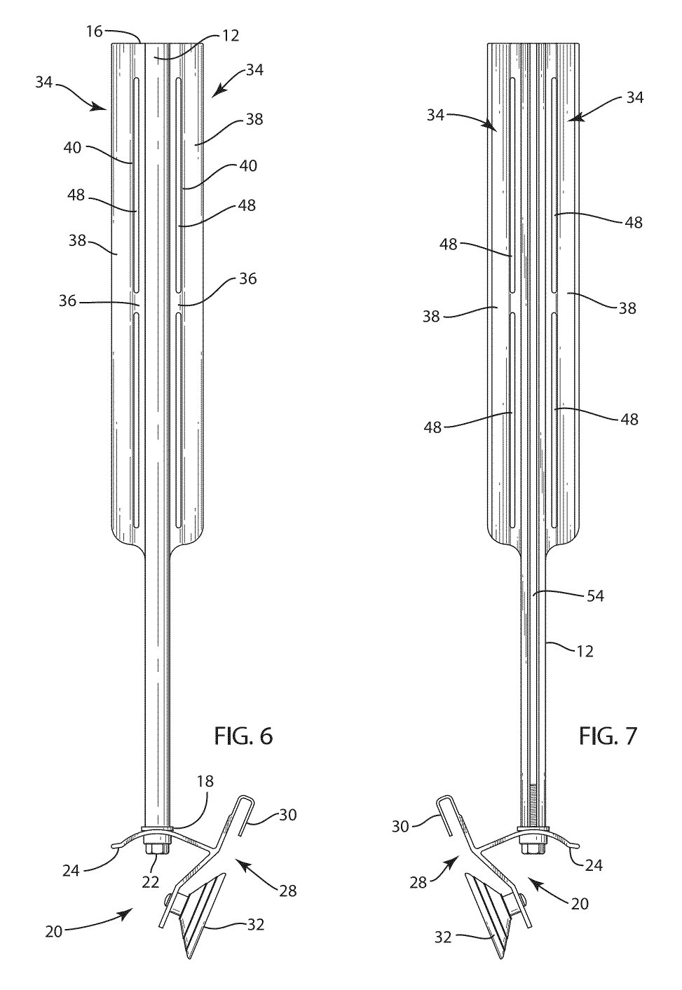

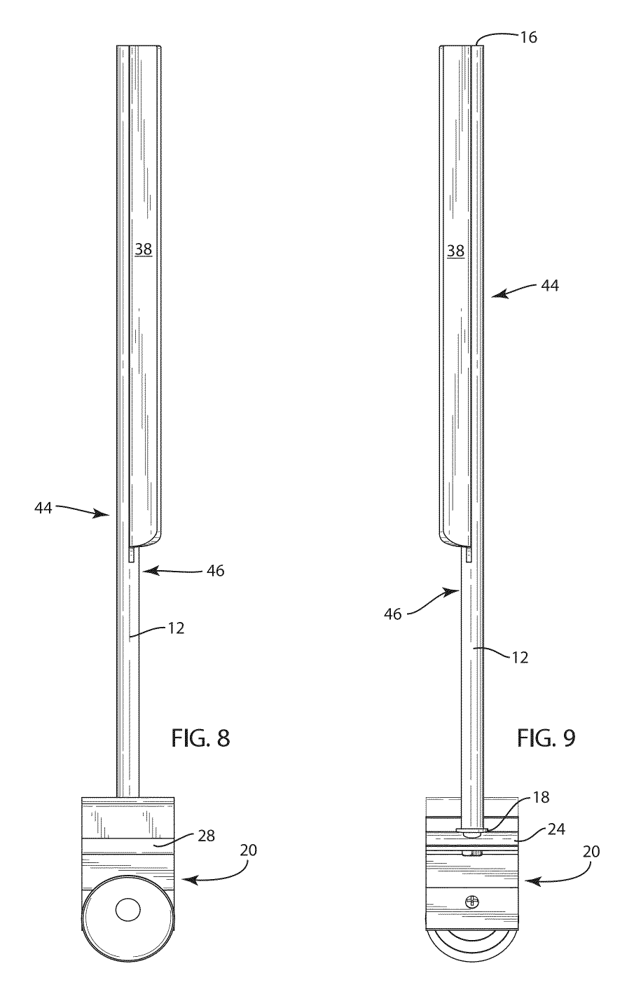

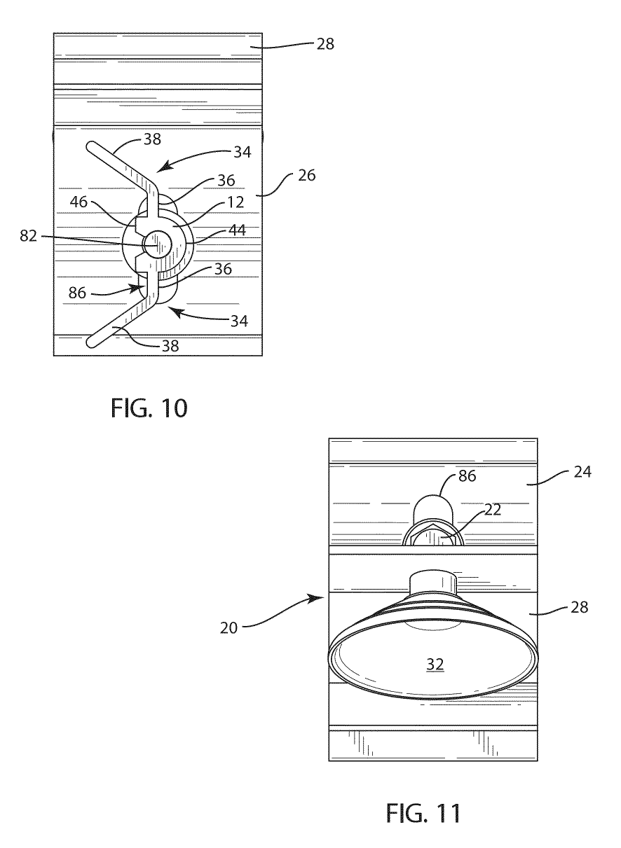

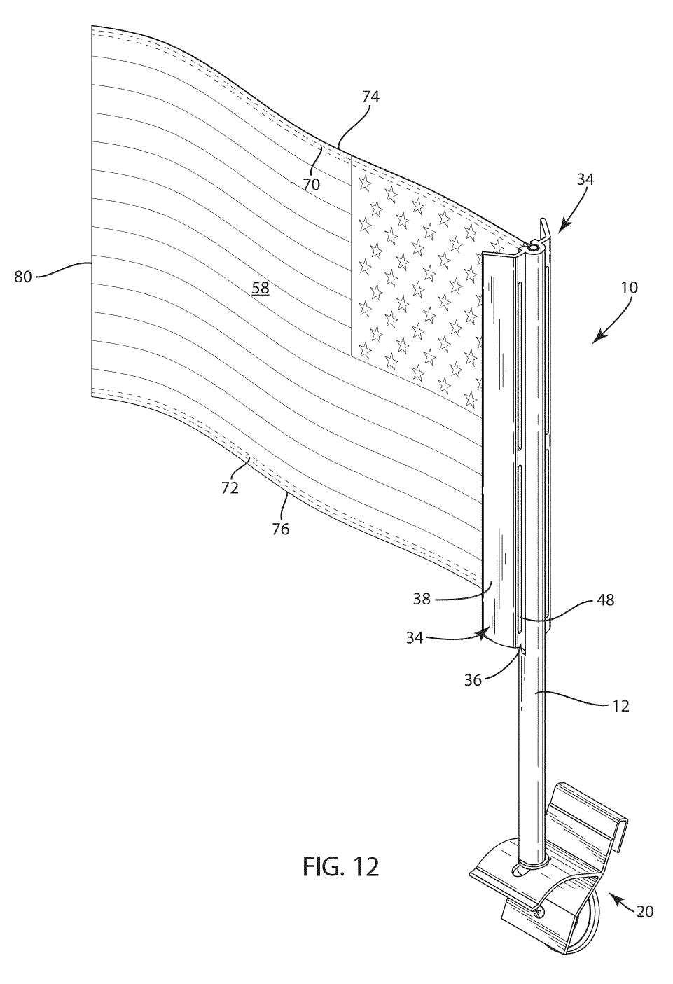

Referring now to FIG. 2, FIG. 2 is a cutaway view of an embodiment of the flag assembly 10 taken along line 2-2 in FIG. 1. In the cutaway view of FIG. 2, an axial bore 54 can be seen through the pole 12 in the elongated dimension 14. The axial bore 54 is axially aligned through the pole 12; however, it is to be understood that the bore 54 can be located in other relationships within the pole 12. A pole slot 56 extends from the bore 54 to the back 46 of the pole 12. The pole slot 56 forms retaining bevels 57, as can be seen in better detail in FIGS. 3 and 4.

A flag 58 includes a fastening loop 60 and a flag body 62. The flag 58 has a vertical dimension 64 and a horizontal dimension 66 and the flag 58 is longer in the horizontal dimension 66 than in the vertical dimension 64. As a non-limiting example, the flag 58 may have the dimensions of 11 inches in the vertical dimension 64 and 16 inches in the horizontal dimension 66. In the embodiment of the flag 58 depicted in FIG. 2, the fastening loop 60 is secured to the flag body 62 by a vertical seam 68. The flag 58 may be constructed by doubling over a piece of material in the horizontal dimension 66 to create a fold 78 along a free edge 80 opposite the fastening loop 60 and securing the folded over material at seam 68 in the vertical dimension 64 and top seam 70 and bottom seam 72 in the horizontal dimension. The top seam 70 and the bottom seam 72 are respectfully located at the top end 74 and the bottom end 76 of the flag 58. In some embodiments, the flag 58 as constructed in the manner disclosed above, has the further advantage of minimizing the weight of the flag at the free edge 80, which in embodiments helps to further reduce the whipping effect and promotes longevity of the flag 58. However, it is understood that this embodiment is non-limiting on the present disclosure and flags constructed of a single piece of material, or having seams at the free edge 80, are also contemplated. In still further embodiments, the seams, exemplarily the vertical seam 68, top seam 70, and bottom seam 72 can include back stitching that helps to prevent or limit any damage to the flag 58 from tearing or loosening of the seams while in use.

The fastening loop 60 of the flag 58 is at least partially disposed within the axial bore 54 and extends out of the pole 12 through the pole slot 56. A retaining rod 82 is inserted through the fastening loop 60 and the bore 54 and held in place by the retaining bevels 57. In some embodiments, the fastening loop 60 and retaining rod 82 are further held in place by the use of a locking screw 84 that is tightened into position to secure the retaining rod 82 and the fastening loop 60. It will be recognized that in alternative embodiments, the retaining rod 82 and the axial bore 54 are dimensioned such that a secure friction fit is obtained between the fastening loop 60, retaining rod 82, axial bore 54, and retaining bevels 57 such that the flag 58 is held in position in relation to the pole 12.

FIG. 3 depicts a top cross sectional view of particularly the bracket 20 taken along line 3-3 of FIG. 1. FIG. 3 further depicts the engagement slot 86 through the engagement surface 26 of the pole adjustment bracket 24. It is to be understood that the engagement slot 86 permits the translation of the bottom 18 of the pole 12 along the engagement surface 26 in the manner as described herein. In some embodiments, the pole adjustment bracket 24 is used in the mounting of the flag assembly 10 to a vehicle in that after the bracket 20 has been mounted on the vehicle, the bottom 18 of the pole 12 is translated along the engagement surface 26, such as to adjust a relative angle between the pole 12 and the portion of the vehicle to which the pole 12 is adjacent. In one particular embodiment, the angle of the pole 12 is adjusted with the pole adjustment bracket 24 such that the pole 12 is generally parallel to an adjacent surface of the vehicle to which the pole 12 is secured.

Referring to FIGS. 4 and 5, FIGS. 4 and 5 both depict a cross sectional view of the flag pole 10 taken along line 4-4. FIG. 5 further includes a plurality of lines representing air flow both through and around the flag pole 10 as in accordance with that described herein. As seen in FIGS. 4 and 5, each of the wings 38 terminate in a wing tips 90. The distance between the wing tips 90 defines a wing span 92. As shown in FIG. 5, the flag pole 10 diverts air flow 88 around the wing assemblies 34 such that the diverted air flow 88 returns to its previous course at a position beyond the free edge 80 of the flag 58. As recognized by the applicants, at high speeds, such as above 30 miles per hour, and in other embodiments above 60 miles per hour, such air flow around the wing assemblies 34 reduces whipping of the free edge 80, but conversely creates a vacuum at the back of the pole 46 that draws the flag 58 against the pole 12, preventing the flag from flying when traveling at high vehicle speeds. The wing assemblies 34 therefore divert some of the air flow through the slots 48 in the wing assembly 34. The air flow diverted through the slot 48 creates parallel air flow 94 along the entire length of the flag 58 in the horizontal dimension 66. The parallel air flow 94 eliminates the vacuum at the back 46 of the pole 12 and additionally helps to cause the flag to fly in the previously described esthetically pleasing manner. The parallel air flow 94 also helps to eliminate whipping of the free edge 80 which promotes longevity of the flag 58.

As can be exemplarily seen in FIGS. 4 and 5, the flag assembly 10 defines a rigid relationship between the flag pole 12 and the wing assembly 34. The flag assembly 10 further generally restrains the positional relationship between the pole 12, wing assemblies 34, and flag 58, as the flag 58 is generally limited to extending in the direction substantially away from the back 46 of the pole 12. In embodiments, the retaining bevels 57 further help to define this relationship between the flag 58, wing assemblies 34, and pole 12 as angle of the bevels 57 define a generalized angle with respect to the pole 12 about which the flag 58 can move. By creating this rigid and defined relationship between the pole 12, wing assemblies 34, and flag 58, the advantages observed in flying a flag at high speeds, exemplarily about 30 miles per hour or above 60 miles per hour, can be achieved.

It is to be noted that in some embodiments, the particular relationship of the dimensions of various components as described herein are desirable in order to create both the parallel air flow 94 and the diverted air flow 88 that is diverted past the free edge 80 of the flag 58. As an exemplary embodiment, the flag 58 is of dimensions 11 inches by 16 inches and each wing 38 is 13 inches in the elongated dimension and 1.5 inches wide. Such an arrangement will produce a wing span 90 that is approximately 3.75 inches across. The slot 48 through the wing assembly 34 is a quarter inch to allow the desired balance of eliminating the vacuum at the back 46 of the pole 12, while creating a small parallel air flow 94 such as to maintain the flag 58 flying at high vehicle speed. In an alternative embodiment, the flag is 18 inches in the horizontal dimension and the wing span is 2.7 inches. In this exemplary embodiment, the inner slot was also a quarter inch. In a still further embodiment, the flag was reduced to 15 inches in the horizontal dimension and the wing span was reduced to 2.32 inches while the slots were reduced to 0.15 inches. As noted in the above description and as can be seen in FIG. 2, in embodiments, the wing assemblies 34 extend beyond the flag 58 in the vertical dimension 64. In such embodiments, the slots 48 in the wing assemblies 34 are dimensioned such that they extend in the vertical direction 64 substantially the entire length of the flag 58 in the vertical dimension 64.

In addition to the exemplary dimensions provided above, generalized relationships between the dimensions can also be controlled in relation to one another. As examples, the ring span 90 is generally increased in relationship to the length of the flag 58 in the horizontal dimension 66. The wing span 90 can be adjusted either by changing the dimensions of the face or the wing, or by changing the angle between the face and the wing. As noted above, in some embodiments of the flag assembly, the wing assemblies extend in the vertical dimension beyond the vertical dimension of the flag. Therefore, if the size of the flag increases in the vertical dimension, the wing assemblies would similarly increase in the vertical dimension as well. While these dimensions are provided in an exemplary manner, they are to be informative, and not limiting on the scope of dimension combinations that can be used within the scope of the flag pole as described herein.

In some embodiments, the flag assembly 10 is constructed as a single structure, such as by an extrusion. In still further embodiments, the wing assemblies 34 can be separate pieces that are welded to the pole 12. In still further embodiments, the wing assemblies 34 are removably secured to the pole 12. In such an embodiment, various sized wing assemblies 34 can be interchangeably attached to the pole 12 such as to use a set of wing assemblies properly dimensioned for the dimensions of the flag 58 to flown. As noted above, wing assemblies 34 can be dimensioned in the vertical dimension or in a width dimension. The wing assemblies can also be dimensioned to adjust an angle of the wing assemblies 34. In still further embodiments, the wing assemblies 34 can be constructed of a decorative material, such as, but not limited to plastic or acrylic and similarly may be releasably secured to the pole 12. In these such embodiments, the wing assemblies 34 can be a further decorative feature of the flag assembly 10. While a detachable wing assembly 34 has herein been disclosed, it is further contemplated that other such embodiments may be included, exemplarily, but not limited to a pole 12 with integral faces 36 and detachable wing 38 releasably secured to the faces 36.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An assembly for flying a flag at high speeds, the assembly comprising:
a pole having an elongated dimension, a front, and a back, wherein the back is configured to receive the flag;
a first wing assembly coupled to the pole, the first wing assembly extends away from the pole angled in the direction of the back of the pole;
a second wing assembly coupled to the pole, the second wing assembly extends away from the pole angled in the direction of the back of the pole;
a first slot through the first wing assembly, the first slot parallel to the elongated dimension of the pole; and
a second slot through the second wing assembly, the second slot parallel to the elongated dimension of the pole.

2. The assembly of claim 1, further comprising:
wherein the first wing assembly comprises a first face extending away from the pole, a first wing coupled to the first face at a first shoulder, and the first slot is located through the first face; and
wherein the second wing assembly comprises a second face extending away from the pole in a direction opposed to the first face, a second wing coupled to the second face at a second shoulder, and the second slot is located through the second face.

3. The assembly of claim 2, wherein the first slot is located through the first face such that an edge of the first slot is aligned on the first shoulder and the second slot is located through the second face such that an edge of the second slot is aligned on the second shoulder.

4. The assembly of claim 3, further comprising a bore through the pole in the elongated dimension, the bore being axially aligned with the pole, wherein the bore extends through the pole at the back of the pole and the bore is configured to receive the flag.

5. The assembly of claim 4, further comprising a retaining rod dimensioned to fit within the bore to secure the flag within the bore.

6. An assembly for flying a flag from a vehicle at high speeds, the assembly comprising:
a pole having an elongated dimension, a top, and a bottom;
a first face extending away from the pole;
a second face extending away from the pole in a direction opposed to the first face;
a first wing coupled to the first face at a first shoulder and extending away from the first shoulder at an obtuse angle to the first face;
a second wing coupled to the second face at a second shoulder and extending away from the second shoulder at an obtuse angle to the second face;
a first slot through the first face, the first slot having an elongated dimension parallel to the elongated dimension of the pole;
a second slot through the second face, the second slot having an elongated dimension parallel to the elongated dimension of the pole;
a bracket secured to the bottom of the pole, the bracket configured to mount to a portion of the vehicle.

7. The assembly of claim 6, wherein the bracket further comprises:
a vehicle mounting bracket configured to securingly engage the vehicle;
a pole adjustment bracket that extends away from the vehicle mounting bracket, the pole adjustment bracket having an engagement surface that defines a plurality of angles at which the bottom of the pole can be secured along the engagement surface.

8. The assembly of claim 7, wherein the angle between the bottom of the pole and the engagement surface is adjusted such that the pole is generally parallel to a surface of the vehicle to which the pole is adjacent.

9. The assembly of claim 7, wherein the pole extends in the elongated dimension past the first face and the second face.

10. The assembly of claim 7, wherein the pole further comprises a front and a back, and further comprising a bore axially aligned through the pole in the elongated dimension, the bore being open to the back of the pole and configured to receive a flag within the bore, the flag extending out the back of the pole.

11. A system for decorating a vehicle, the system comprising:
a pole having an elongated dimension, a top, a bottom, a front, and a back;
an axial bore through the pole;
a slot extending from the axial bore, through the pole to the back of the pole;
a flag comprising a fastening loop along a vertical dimension and a flag body extending in a horizontal direction away from the fastening loop, wherein the fastening loop is partially received within the axial bore and extends out of the pole through the slot and the flag body extends generally away from the back of the pole;
a first face extending away from the pole;
a second face extending away from the pole in a direction opposed to the first face;
a first wing coupled to the pole by the first face, the first wing being coupled to the first face at a first shoulder and extending away from the first shoulder at an obtuse angle to the first face;
a second wing coupled to the pole by the second face, the second wing being coupled to the second face at a second shoulder and extending away from the second shoulder at an obtuse angle to the second face;
a first slot through the first face, the first slot having an elongated dimension parallel to the elongated dimension of the pole;
a second slot through the second face, the second slot having an elongated dimension parallel to the elongated dimension of the pole; and
a bracket secured to the bottom of the pole and configured to mount to a portion of the vehicle.

12. The system of claim 11, wherein the first and second wings divert air flow around the flag, while the first and second slots create even flows of air parallel along the flag body, and the combination of air flows allows the flag to fly at vehicle speeds in excess of 30 miles per hour.

13. The system of claim 12, wherein the first and second wings terminate in respective wing tips and a distance between the respective wing tips defines a wingspan and the wingspan is dimensioned relative to the length of the flag in the horizontal direction.

14. The system of claim 13, wherein the wingspan is adjustable based upon the length of the first and second wings.

15. The system of claim 14, wherein the first and second wings are interchangeably coupled to the pole.

16. The system of claim 12, wherein the flag body is constructed of an overlapped piece of material, the overlapped piece of material being secured at top and bottom ends along the horizontal direction, and an unsecured fold along an edge in the vertical direction;
wherein the unsecured fold reduces weight along the edge of the flag.

17. The system of claim 12, wherein the bracket comprises:
a vehicle mounting bracket configured to securingly engage the vehicle;
a pole adjustment bracket that extends away from the vehicle mounting bracket, the pole adjustment bracket having an engagement surface that defines a plurality of angles at which the bottom of the pole can be secured along the engagement surface.

18. The assembly of claim 17, wherein the bottom of the pole engages the engagement surface at an angle of the plurality of angles such that the pole is generally parallel to a vehicle surface to which the pole is adjacent.

19. The assembly of claim 12, wherein the first face and the second face are longer in an elongated dimension than the vertical dimension of the flag, and the pole extends in the elongated dimension past the first face and the second face in the elongated dimension.

20. The assembly of claim 12, further comprising:
retaining bevels along the slot, the retaining bevels defining an angle within which the fastening loop can extend from the slot; and
a retaining rod axially disposed through the bore and the fastening loop to secure the fastening loop within the bore.
